(19) United States
(12) Patent Application Publication
(10) Pub. No.: US 2009/0150341 A1
(43) Pub. Date: Jun. 11, 2009

(54) GENERATION OF ALTERNATIVE PHRASINGS FOR SHORT DESCRIPTIONS

(75) Inventors: Timothy S. Paek, Sammamish, WA (US); Yun-Cheng Ju, Bellevue, WA (US); Christopher A. Meek, Kirkland, WA (US)

Correspondence Address: AMIN, TUROCY & CALVIN, LLP, 127 Public Square, 57th Floor, Key Tower, CLEVELAND, OH, 44114, US

(73) Assignee: MICROSOFT CORPORATION, Redmond, WA (US)

(21) Appl. No.: 11/951,038

(22) Filed: Dec. 5, 2007

(51) Int. Cl. G06F 7/10; G06F 17/30

(52) U.S. Cl. 707/3; 707/E17.014

(57) ABSTRACT

The claimed subject matter provides systems and/or methods that effectuate generation of alternative expressions or phrasings for short descriptions, proper nouns or places. The system can include devices that select and associate an item with a prompt, displays the selected item and then obscures the item with the prompt associated with the item, elicits a response from users to the prompt based on a motivational statement constructed to solicit an appropriate response from the user. The response elicited from the user and the item selected associated with one another and then persisted to storage media.

### BACKGROUND

Speech recognition technology enables a computer to automatically convert an acoustic signal uttered by users into textual words, freeing them from constraints of the standard desktop style interface (such as, for example, mouse pointer, menu, icon, and window, etc.). The technology has been playing a key role in enabling and enhancing human-machine communications. Speaking is the most natural form of human-to-human communications. One learns how to speak in childhood, and people exercise speaking communication skills on a daily basis. The possibility to translate this naturalness of communication into the capability of a computer is a logical extension and expectation, since computers are equipped with substantial computing and storage capabilities.

Nonetheless, the expectation that computers should be good at speech has not yet become a reality. One reason for this is that speech input is more prone to error due to imperfection of speech recognition technology in dealing with variabilities from speakers, speaking style, and acoustic environment. While spoken language has the potential to provide a natural interaction model, the difficulty in resolving ambiguity of spoken language and the high computational requirements of speech technology have so far prevented it from becoming commonplace.

### SUMMARY

The following presents a simplified summary in order to provide a basic understanding of some aspects of the disclosed subject matter. This summary is not an extensive overview, and it is not intended to identify key/critical elements or to delineate the scope thereof. Its sole purpose is to present some concepts in a simplified form as a prelude to the more detailed description that is presented later.

The claimed subject matter in accordance with an aspect provides systems and methods facilitate and effectuate generation of alternative expressions or phrasings for proper nouns, short descriptions, or places. The system receives listings and/or input from users and utilizes the listings to identify and associate items with prompts that can have been stored in databases, data warehouses, or local or remote storage media. The system further displays the identified item and then obscures the item with a prompt, at which point a motivational statement can be displayed to elicit responses from the users, the responses can thereafter be persisted on storage media for future or further analysis.

To the accomplishment of the foregoing and related ends, certain illustrative aspects of the disclosed and claimed subject matter are described herein in connection with the following description and the annexed drawings. These aspects are indicative, however, of but a few of the various ways in which the principles disclosed herein can be employed and is intended to include all such aspects and their equivalents. Other advantages and novel features will become apparent from the following detailed description when considered in conjunction with the drawings.

### BRIEF DESCRIPTION OF THE DRAWINGS

FIG. 1 illustrates a machine-implemented system that effectuates and facilitates generation of alternative expressions or phrasings for proper nouns, short descriptions, or places in accordance with the claimed subject matter.

FIG. 2 provides a more detailed depiction of an illustrative analysis component that effectuates and facilitates generation of alternative expressions or phrasings for short descriptions, proper nouns or places in accordance with an aspect of the claimed subject matter.

FIG. 3 illustrates a machine-implemented system that effectuates and facilitates generation of alternative expressions or phrasings for proper nouns, short descriptions, or places in accordance with a further aspect of the claimed subject matter.

FIG. 4 provides a more detailed depiction of an inquiry component that effectuates and facilitates generation of alternative expressions or phrasings for proper nouns, places, or short descriptions in accordance with an aspect of the claimed subject matter.

FIG. 5 illustrates a machine-implemented system that effectuates and facilitates generation of alternative expressions or phrasings for short descriptions, proper nouns or places in accordance with an aspect of the claimed subject matter.

FIG. 6 illustrates a machine-implemented system that effectuates and facilitates generation of alternative expressions or phrasings for short descriptions, proper nouns or places in accordance with a further aspect of the claimed subject matter.

FIG. 7 illustrates yet another aspect of the machine implemented system that effectuates and facilitates generation of alternative expressions or phrasings for proper nouns, places, or short descriptions in accordance with an aspect of the claimed subject matter.

FIG. 8 depicts a further illustrative aspect of the machine implemented system that effectuates and facilitates generation of alternative expressions or phrasings for proper nouns, short descriptions, or places in accordance with an aspect of the claimed subject matter.

FIG. 9 illustrates another illustrative aspect of a system implemented on a machine that effectuates and facilitates generation of alternative expressions or phrasings for proper nouns, short descriptions, or places in accordance of yet another aspect of the claimed subject matter.

FIG. 10 depicts yet another illustrative aspect of a system that effectuates and facilitates generation of alternative expressions or phrasings for short descriptions, proper nouns or places in accordance with an aspect of the subject matter as claimed.

FIG. 11 depicts another illustrative aspect of a system that effectuates and facilitates generation of alternative expressions or phrasings for short descriptions, proper nouns or places in accordance with an aspect of the subject matter as claimed.

FIG. 12 illustrates another illustrative aspect of a system implemented on a machine that effectuates and facilitates generation of alternative expressions or phrasings for proper nouns, short descriptions, or places in accordance of yet another aspect of the claimed subject matter.

FIG. 13 illustrates a flow diagram of a machine implemented methodology that effectuates and facilitates generation of alternative expressions or phrasings for proper nouns, short descriptions, or places in accordance with an aspect of the subject matter as claimed.

FIG. 14 depicts an illustrative flow diagram of a machine implemented methodology that facilitates and effectuates generation of alternative expressions or phrasings for short descriptions, proper nouns or places in accordance with an aspect of the subject matter as claimed.

FIG. 15 illustrates a block diagram of a computer operable to execute the disclosed system in accordance with an aspect of the claimed subject matter.

FIG. 16 illustrates a schematic block diagram of an exemplary computing environment for processing the disclosed architecture in accordance with another aspect.

### DETAILED DESCRIPTION

The subject matter as claimed is now described with reference to the drawings, wherein like reference numerals are used to refer to like elements throughout. In the following description, for purposes of explanation, numerous specific details are set forth in order to provide a thorough understanding thereof. It may be evident, however, that the claimed subject matter can be practiced without these specific details. In other instances, well-known structures and devices are shown in block diagram form in order to facilitate a description thereof.

It should be noted at the outset that while the claimed subject matter is explicated for the purposes of clarity, simplicity of exposition, and comprehension, in the context of Automated Directory Assistance (ADA), the subject matter as claimed is not necessarily so limited. The claimed subject matter can find applicability in a plethora of other contexts, mechanisms, and applications beyond the Automated Directory Assistance (ADA) paradigm. For instance, the claimed subject matter can find applicability in the realm of information retrieval where speech (e.g., voice utterances, vocalizations, and/or phrasings) is employed to input search criteria and initiate a search of a domain space without departing from the intent and scope of the subject matter as claimed. Accordingly, any and all such applicability, and derivations thereof, can be deemed to fall within the ambit of the claimed subject matter.

Automated Directory Assistance (ADA) generally allows users to request telephone or address information of residential and business listings using speech recognition. The main objective of Automated Directory Assistance (ADA) is typically to reduce the need and cost for human operators who have traditionally provided this service. Automating this task, however, has to date proven challenging as callers frequently express listings differently than how they are registered in the directory. For example, the listing “Kung Ho Cuisine of China” can be expressed in abbreviated form (e.g., “Kung Ho”), or include words not in the registered title (e.g., Kung Ho Chinese Restaurant”), or be pronounced in a different way (e.g., “Hung Hu”). In order to deal with user variations, Automated Directory Assistance (ADA) systems generally require transcriptions of alternative phrasings for the listings as training data. Unfortunately, there are over 18 million business listings in the United States alone. Collecting and transcribing data of that scale can involve enormous effort and cost. As such, a framework in which data can be contributed voluntarily by a large number of users on the Internet (or individuals paid to derive such alternative phrasings) for different local areas can be of tremendous value.

The problem of obtaining human generated, alternative phrasings is not unique to Automated Directory Assistance (ADA). For instance, in natural language understanding, it is important to know that multiple proper names can refer to the same person (e.g., Bush, George W., Mr. President, etc.). However, because the primary task of Automated Directory Assistance (ADA) is to find a unique residential or business listing, alternative phrasings can pose problems for Automated Directory Assistance (ADA) usability. As such, researchers have pursued various methods, all of which require data that the claimed subject matter can provide.

Recent research on Automated Directory Assistance (ADA) systems has focused on the search approach in which recognized text is used to match against the set of business listings. This approach typically uses n-gram language models which, like dictation models, compress and generalize across listings and their observed expressions. No matter whether alternative expressions are included in the grammar or used to train n-grams, the claimed subject matter can provide transcribed training data.

Another method for dealing with alternative phrasings can be to generate user expressions using transduction rules applied to directory listings. Again, these rules must typically be induced from initial training data. Furthermore, validating that the generated expressions are indeed possible user expressions can also be a problem, which the claimed subject matter can circumvent by using human users to generate the data.

The problem of obtaining alternative phrasings for proper nouns or short descriptions can be viewed as part of a larger problem of leveraging human computation to address tasks that cannot be easily automated. One way to leverage human computation can be to utilize a software platform to programmatically access and incorporate paid human intelligence into an application. Another way can be to exchange human computation for entertainment in the context of a computer game. In fact, in many instances, researchers have regularly sought to use games to tackle machine learning problems such as image classification, generating natural language descriptions for images, and paraphrasing journalistic sentences for machine translation, for example.

The subject matter as claimed and disclosed herein in accordance with an aspect provides systems and methods that elicit transcribed, alternative phrasings for proper nouns and/or alternative expressions for places; in particular, businesses listed in the telephone directory, or short descriptions elicited from individuals. In order to address the problem of obtaining such alternative phrasings, the claimed subject matter, for example, can leverage human computation and transcription via computer games.

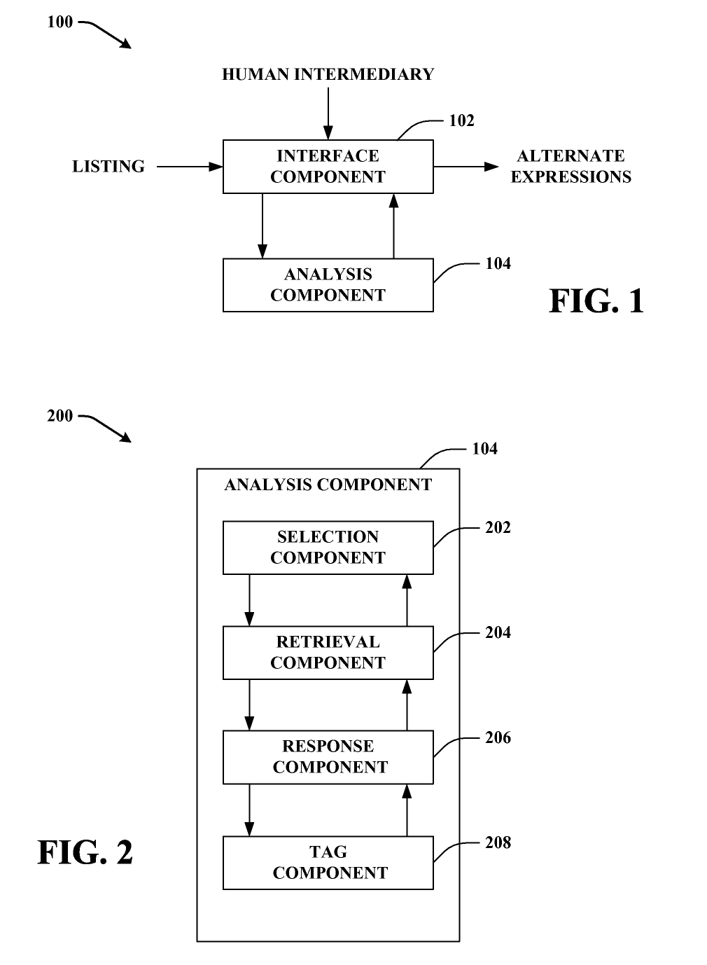

FIG. 1 depicts a system 100 that effectuates and facilitates generation of alternative expressions or phrasings for short descriptions, proper nouns or places. System 100 can include interface component 102 (hereinafter referred to as “interface 102”) that can receive input in the form of listings (e.g., business listings for Automated Directory Assistance (ADA) purposes, search terms for the purposes of information retrieval, short descriptions solicited from individuals, etc.). Additionally, interface 102 can also receive input from one or more human intermediary (e.g., users, paid subjects, and the like) who respond to prompts or queries generated by analysis component 104. Further, interface 102 in this illustrative aspect of the claimed subject matter can distribute, in transcribed form, alternate expressions or phrasings for short descriptions, proper nouns or places based at least in part on the received listings and elicited input from the human intermediaries for use in Automated Directory Assistance (ADA) and/or natural language understanding applications, for instance.

Interface 102 can provide various adapters, connectors, channels, communication pathways, etc. to integrate the various components included in system 100 into virtually any operating system and/or database system and/or with one another. Additionally, interface 102 can provide various adapters, connectors, channels, communication modalities, etc., that can provide for interaction with the various components that can comprise system 100, and/or any other component (external and/or internal), data, and the like, associated with system 100.

As stated supra, system 100 can include analysis component 104 that utilizes listings received from external sources (e.g., databases, the Internet, associated persistence means, etc.) together with repositories (not shown) of prompts (e.g., images, music jingles, corporate logos, viral videos, advertising clips, and the like) to generate queries that elicit responses from human intermediaries. Analysis component 104 can thereafter associate the listings and the responses elicited from the human intermediaries to provide alternate expressions or phrasings for the received listings based at least in part on the prompts.

In an aspect of the claimed subject matter, analysis component 104 can accept responses from multiple human intermediaries wherein the human intermediaries can be paired with one another. Additionally and/or alternatively, human intermediaries can be “bots” that emulate live intermediaries by using previously solicited or elicited alternative expressions or phrasings.

In one illustrative aspect, the claimed subject matter can be framed as a marketing game that tests the intermediary's ability to “spot social trends” by having them identify who they think would be likely customers of various business establishments. For example, human intermediaries can be shown randomly selected photographs of all kinds of people—from individuals to families, bakers to zoo keepers, Americans to New Zealanders. The business establishments can be indicated by and/or retrieved from directory listings submitted as input.

The illustrative marketing game can proceed as follows, wherein analysis component 104 selects (e.g., in a predetermined order or in a random order) business establishments from the supplied directory listings. Once analysis component 104 has identified business establishments for which to solicit responses, analysis component 104 can retrieve appropriate prompts (e.g., photographs, audio/visual clips, etc.) from one or more associated repositories or persistence means (e.g., databases, the Internet, local storage devices, . . . ) and present (e.g., display, playback, etc.) the prompts to elicit responses from players (e.g., human intermediaries). These prompts can vary along different attributes. For instance, where photographs are employed as stimuli to elicit response, different attributes can include group, occupation, and/or nationality. Generally, appropriate prompts can be paired so that they differ in at least one attribute; however, the claimed subject matter, as will be appreciated by those conversant in the technology, is not so limited, as prompts differing markedly in attributes can be retrieved and/or utilized singly or in varying multiples to achieve the same or similar objectives. The player's task at this point is to match each of the prompts with the business establishments selected and/or identified. Players can perform the matching of prompts with business establishments by typing their responses beneath the displayed prompts, for example. Once players have completed the task of matching each prompt with business establishments, each player's responses, if applicable, can be shown to other players.

In accordance with a further aspect of the claimed subject matter, players (e.g., where there are multiple players) can be awarded points for matching answers. Top ranked players in this instance can be ascertained by the total number of points garnered by a player in the least amount of time, for example.

The design of the subject matter as claimed can be premised on the psychological notion that in free recall of text, adults are likely to reproduce the gist, or “essence” of the text instead of a verbatim reproduction. The gist can be propositional in nature, as seen for example, in the way that people sometimes add the word restaurant to a business listing. By showing and removing business names from the display, players typically must commit them to memory. Furthermore, because the game can typically be timed, players can be motivated to provide short names to identify businesses. It should be noted that during setup and initialization of the game, players can be notified that they do not have to write the verbatim name of the business, but rather enough so that analysis component 104 can compare their answers to their partners' or with some reference business name.

Another design consideration employed by the claimed subject matter can include the social aspect of the game. To succeed, players typically must not only guess which businesses are likely to have the attributes included in the prompts (e.g., photographs), but they generally must also match their guesses with their partners'. This type of collaboration it has been found can motivate players to provide reasonable answers (e.g., it takes two or more people to win) and to play multiple times. By keeping track of the top players, the claimed subject matter through utilization of the gaming paradigm, for example, can add the desire to achieve reputation in the game as motivation.

In a further illustrative aspect, the claimed subject matter can ask human intermediaries to describe actions. For instance, certain applications or application suites can be configured to employ master templates that define global parameters (e.g., fonts, backgrounds, etc.) that can be utilized throughout the extent of particular applications or application suites. In many instances users of these applications or application suites can be unaware that these parameters have been defined globally. Thus, when such users wish to modify one of these globally defined parameters they can typically become frustrated when they discover that their “changes” have not been saved. The subject matter as claimed can be employed to provide assistance in such situations wherein short descriptions elicited from users during times of difficulty and/or frustration can be matched to previously acquired phrases gleaned from human intermediaries placed in similar positions of difficulty and/or frustration.

FIG. 2 provides further illustration 200 of analysis component 104 that in accordance with an aspect includes selection component 202 that can randomly select businesses from supplied listings requested or retrieved from one or more data repositories, such as, for example, databases, data warehouses, the Internet, local and remote persistence means, and the like. Alternatively and/or additionally, selection component 202 can follow a predetermined sequence and/or can spontaneously determine an order in which to select business from the supplied listings. Selection component 202 can select business from supplied listings singularly or in various multiples (e.g., pairs, triplets, . . . ) and can thereafter cause the selected business or businesses to be displayed so that human intermediaries can perceive (e.g., view, hear, etc.) the displayed selection(s).

Analysis component 104 can also include retrieval component 204 that can locate appropriate prompts or other mnemonic devices that commonly can be associated with businesses selected by selection component 202. Appropriate prompts or mnemonic devices can include photographs, audio clips, corporate trademarks, videos, and the like. Prompts or mnemonic devices can typically be chosen by retrieval component 204 based at least in part on affinities between the prompts obtained by retrieval component 204 and businesses identified by selection component 202. For example, a business that is perceived as being a wholesome family restaurant can be associated with prompts reflective of this attribute (e.g., photographs of families can be displayed). Retrieval component 204 can acquire representative prompts or mnemonic devices from associated repositories, such as, for example, local and distributed persistence means, databases, data warehouses, the Internet, or the like. Once retrieval component 204 has obtained sufficient prompts or mnemonic devices to effectuate a correspondence between the selected business or businesses identified by selection component 202, retrieval component 204 can cause the corresponding prompts to be displayed so that human intermediaries can view the displayed prompts. For example, if selection component 202 identifies and displays a business called “Reginald's Flower Shop”, retrieval component 204 can obtain and display images, such as, photographs of valentine hearts, puppies, kittens, boxes of chocolates, diamond rings, etc. It should be noted that when retrieval component 204 displays prompts, it opaquely overlays or overwrites the display initiated by selection component 202 so that the business name is no longer perceivable to the human intermediary. For instance, utilizing the previous example, retrieval component 204 can overlay images, such as photographs of puppies, over the business name “Reginald's Flower Shop” so that the business name is obscured to the human intermediary.

Analysis component 104 can additionally include response component 206 that can generate statements (e.g., motivational statements) related to the businesses identified by selection component 202 and prompts obtained and displayed by retrieval component 204, and designed to elicit one or more responses from human intermediaries. Response component 206 can utilize artificial intelligence modalities and/or machine learning techniques in order to generate appropriate statements related both to the businesses identified by selection component 202 and prompts obtained by retrieval component 204. An illustrative statement generated by response component 206 can be, for example, “Please match the business name with the image”. Thus, in the foregoing example of “Reginald's Flower Shop”, where an image of valentine hearts is displayed, a human intermediary when requested to “Please match the business name with the image”, and can enter (e.g., in a bounded box provided) “Reg's Flower Shop”, “The Flower Shoppe”, “Flower Shop”, “Reggie's Shop”, and the like, for instance.

In addition, analysis component 104 can include tag component 208 that can receive responses entered by the human intermediaries and thereafter associate such responses to the business. For instance, once again utilizing the “Reginald's Flower Shop” example, where human intermediaries enter “Reg's Flower Shop”, “The Flower Shoppe”, “Flower Shop”, or “Reggie's Shop”, tag component 208 can associate the elicited response with the business name “Reginald's Flower Shop”. The tag (e.g., the elicited response) associated with the business name thus can provide an alternate phrasing for the business at issue. Business names together with associated tag identifiers of elicited alternative phrasings can then be output as a transcribed file of alternative expressions that can be utilized by an Automated Directory Assistance (ADA) service and/or a natural language understanding application.

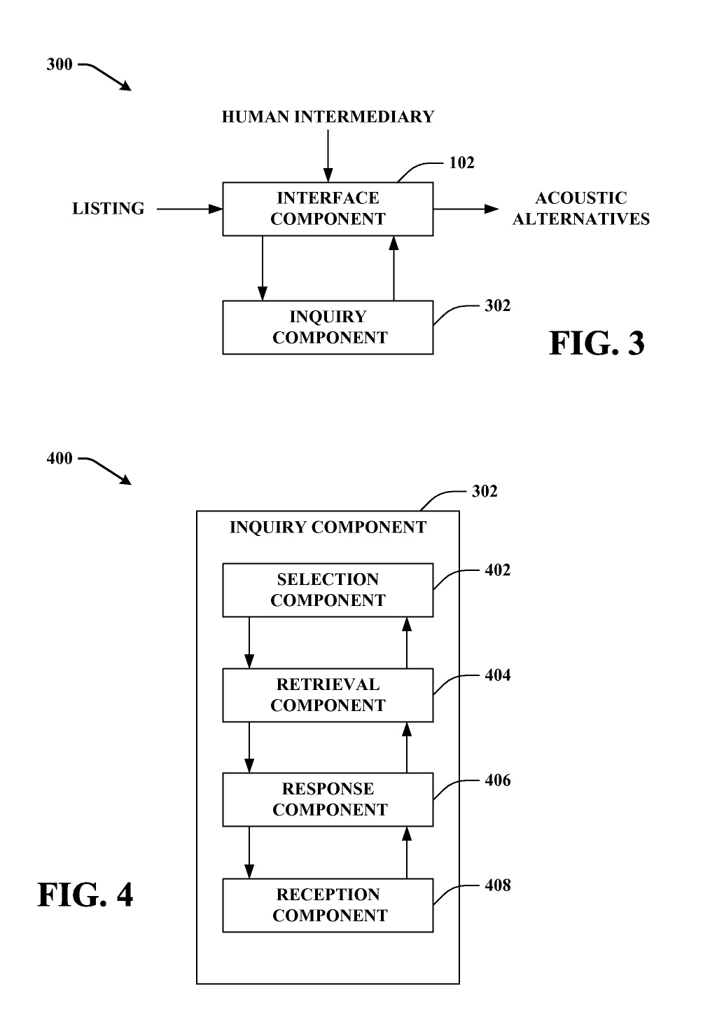

FIG. 3 depicts system 300 that effectuates and facilitates generation of alternative expressions or phrasings for proper nouns, short descriptions, or places in accordance with another aspect of the claimed subject matter. As illustrated, system 300 can include interface 102 that can receive input in the form of listings (e.g., business listings for Automated Directory Assistance (ADA) purposes, search terms for the purposes of information retrieval, etc.). Interface 102 can also receive input from one or more human intermediary who can respond to prompts or queries generated by inquiry component 302. Further, interface 102 in this aspect of the claimed subject matter can distribute, in compressed or uncompressed audio formats (e.g., WAV, WMA, MP3, and the like), alternate expressions or phrasings (e.g., as a WAV file) based at least in part on the received listings and elicited input from the human intermediaries for use in Automated Directory Assistance (ADA) and/or natural language understanding applications, for instance.

System 300 can also include inquiry component 302 that can employ the received listings in conjunction with prompts and/or mnemonic devices, such as viral videos, corporate logos, advertising media, photographs, and the like, to create queries that can motivate human intermediaries to provide appropriate responses (e.g., provide voice utterances in response to the queries). Once inquiry component 302 has elicited an appropriate response from human intermediaries, it can associate the listings with the corresponding elicited response and persist the responses in one or more audio format, such as in a WAV or MP3 format for subsequent utilization by other applications.

FIG. 4 provides further depiction 400 of inquiry component 302. Inquiry component 302 can include selection component 402 that selects businesses from supplied listings received or solicited from data repositories, such as, databases data warehouses, local and remote storage devices, the Internet, etc. Selection component 402 can utilize a pre-established ordering (e.g., iterate through the list from the beginning), or employ some other ordering scheme in order to select businesses from the supplied listings. Selection component 402 can select business names from the supplied listings singularly or in various multiples. Once selection component 402 has identified businesses names to use, it can cause the selected business names to be displayed so that the human intermediaries can perceive the displayed selections.

Additionally, inquiry component 302 can include retrieval component 404 that based at least in part on the business names selected by selection component 402 can search for appropriate mnemonic prompts with which to motivate the human intermediaries to provide suitable responses. Illustrative and appropriate mnemonic prompts can include audio clips, photographs, viral videos, and the like. Typically, appropriate mnemonic prompts can be selected by retrieval component 404 based on a correspondence in attributes between the mnemonic prompt identified by retrieval component 404 and business selected by selection component 402. For example, a business listing for an upscale dining establishment can be associated with mnemonic prompts reflective of this attribute (e.g., videos of well attired couples dining at candle lit tables with waiters hovering solicitously in the background). Retrieval component 404 can locate such mnemonic prompts from one or more persisting media, such as remote and local storage devices, databases, the Internet, etc. Having obtained sufficient and appropriate mnemonic prompts retrieval component 404 can cause mnemonic prompts to be overlaid over top of the business names previously displayed by selection component 402, thereby obscuring the name of the business.

Inquiry component 302 can also include response component 406 that can generate statements related to the businesses identified by selection component 402 and mnemonic prompts obtained and displayed by retrieval component 404 and in order to elicit necessary responses from human intermediaries. Response component 406 in order to effectuate its ends, can utilize artificial intelligence and/or machine learning techniques in order to generate appropriate statements related both to the businesses identified by selection component 402 and prompts obtained by retrieval component 404.

Moreover, inquiry component 302 can include reception component 408 that can record responses (e.g., vocal expressions enunciated by human intermediaries in response to mnemonic prompt presented by response component 406) entered by the human intermediaries and thereafter associate such responses to the business name selected by selection component 402. For instance, once again utilizing the “Reginald's Flower Shop” example, where human intermediaries utter “Reg's Flower Shop”, “The Flower Shoppe”, “Flower Shop”, or “Reggie's Shop”, reception component 408 can record (e.g., through a recording device associated with system 400) the elicited responses and associate these responses with the business name “Reginald's Flower Shop”, thereby providing alternate phrasing or expressions for the business at issue. The recording together with the associated business name can then be output as an audio formatted file that can be used by Automated Directory Assistance (ADA) and/or natural language understanding applications, for example.

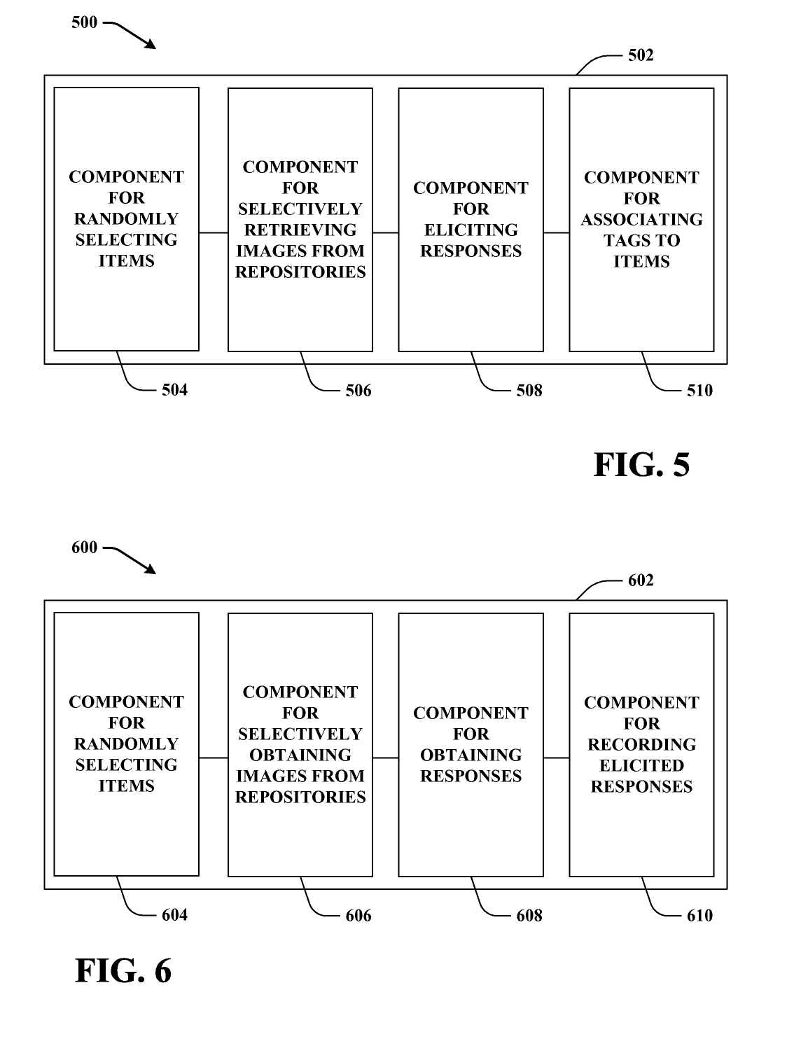

FIG. 5 illustrates a system 500 that effectuates and facilitates generation of alternative expressions or phrasings for proper nouns, or places, short descriptions. For example, system 500 can reside at least partially within a machine. It is to be appreciated that system 500 is represented as including functional blocks, which may be functional blocks that represent functions implemented by a processor, software, or combination thereof (e.g., firmware). System 500 includes a logical grouping 502 of components that can act in conjunction. For instance, logical grouping 502 can include a component for randomly selecting items 504. Further, logical grouping 502 can comprise a component for selectively retrieving images from repositories 506. Also, logical grouping 502 can include a component for generating one or more queries 508. Additionally, logical grouping 502 can include a component for associating tags to items 510.

FIG. 6 illustrates a system 600 that effectuates and facilitates generation of alternative expressions or phrasings for short descriptions, proper nouns or places. For instance, system 600 can reside at least partially within a machine. It is to be appreciated that system 600 is represented as including functional blocks, which may be functional blocks that represent functions implemented by a processor, software, or combination thereof (e.g., firmware). System 600 can include a logical grouping 602 of components that can act in conjunction. For example, logical grouping 602 can include a component for randomly selecting items 604. Further, logical grouping 602 can comprise a component for selectively obtaining images from image repositories 606. Also, logical grouping 602 can include a component for generating one or more queries 608. Additionally, logical grouping 602 can also include a component for recording elicited responses in an audio format 610.

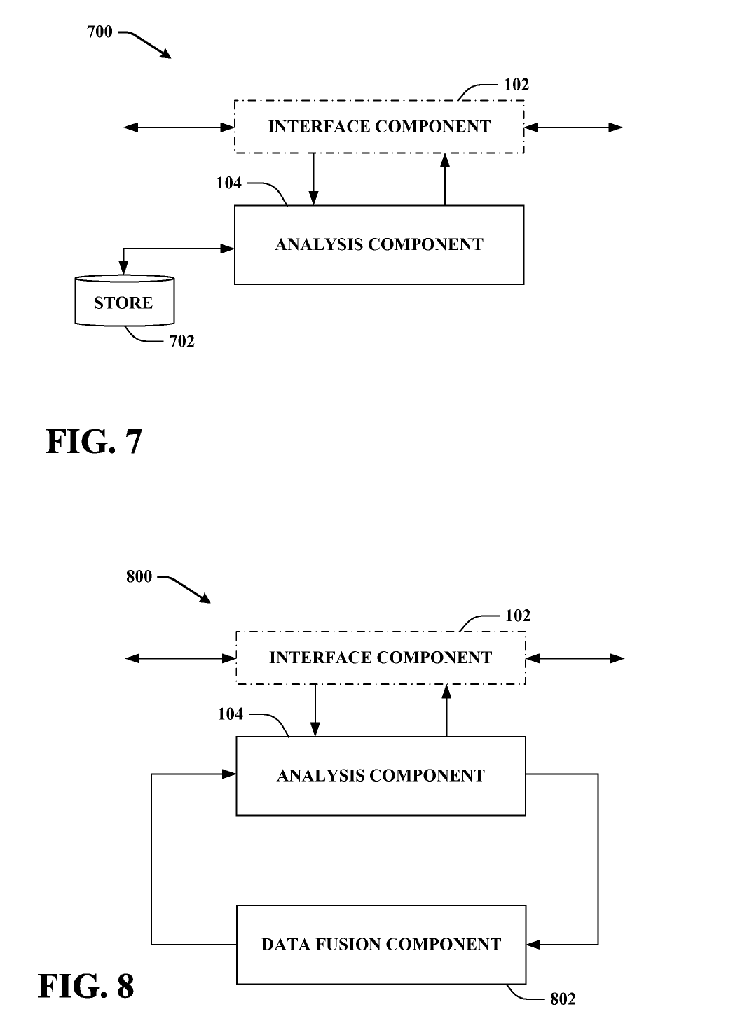

FIG. 7 depicts an aspect of a system 700 that effectuates and facilitates generation of alternative expressions or phrasings for short descriptions, proper nouns or places. System 700 can include store 702 that can include any suitable data necessary for analysis component 104 or inquiry component 302 to facilitate their aims. For instance, store 702 can include information regarding user data, data related to a portion of a transaction, credit information, historic data related to a previous transaction, a portion of data associated with purchasing a good and/or service, a portion of data associated with selling a good and/or service, geographical location, online activity, previous online transactions, activity across disparate network, activity across a network, credit card verification, membership, duration of membership, communication associated with a network, buddy lists, contacts, questions answered, questions posted, response time for questions, blog data, blog entries, endorsements, items bought, items sold, products on the network, information gleaned from a disparate website, information gleaned from the disparate network, ratings from a website, a credit score, geographical location, a donation to charity, or any other information related to software, applications, web conferencing, and/or any suitable data related to transactions, etc.

It is to be appreciated that store 702 can be, for example, volatile memory or non-volatile memory, or can include both volatile and non-volatile memory. By way of illustration, and not limitation, non-volatile memory can include read-only memory (ROM), programmable read only memory (PROM), electrically programmable read only memory (EPROM), electrically erasable programmable read only memory (EEPROM), or flash memory. Volatile memory can include random access memory (RAM), which can act as external cache memory. By way of illustration rather than limitation, RAM is available in many forms such as static RAM (SRAM), dynamic RAM (DRAM), synchronous DRAM (SDRAM), double data rate SDRAM (DDR SDRAM), enhanced SDRAM (ESDRAM), Synchlink® DRAM (SLDRAM), Rambus® direct RAM (RDRAM), direct Rambus® dynamic RAM (DRDRAM) and Rambus® dynamic RAM (RDRAM). Store 702 of the subject systems and methods is intended to comprise, without being limited to, these and any other suitable types of memory. In addition, it is to be appreciated that store 702 can be a server, a database, a hard drive, and the like.

FIG. 8 provides yet a further depiction of a system 800 that effectuates and facilitates generation of alternative expressions or phrasings for proper nouns, short descriptions, or places in accordance with an aspect of the claimed subject matter. As depicted, system 800 can include a data fusion component 802 that can be utilized to take advantage of information fission which may be inherent to a process (e.g., receiving and/or deciphering inputs) relating to analyzing inputs through several different sensing modalities. In particular, one or more available inputs may provide a unique window into a physical environment (e.g., an entity inputting instructions) through several different sensing or input modalities. Because complete details of the phenomena to be observed or analyzed may not be contained within a single sensing/input window, there can be information fragmentation which results from this fission process. These information fragments associated with the various sensing devices may include both independent and dependent components.

The independent components may be used to further fill out (or span) an information space; and the dependent components may be employed in combination to improve quality of common information recognizing that all sensor/input data may be subject to error, and/or noise. In this context, data fusion techniques employed by data fusion component 802 may include algorithmic processing of sensor/input data to compensate for inherent fragmentation of information because particular phenomena may not be observed directly using a single sensing/input modality. Thus, data fusion provides a suitable framework to facilitate condensing, combining, evaluating, and/or interpreting available sensed or received information in the context of a particular application.

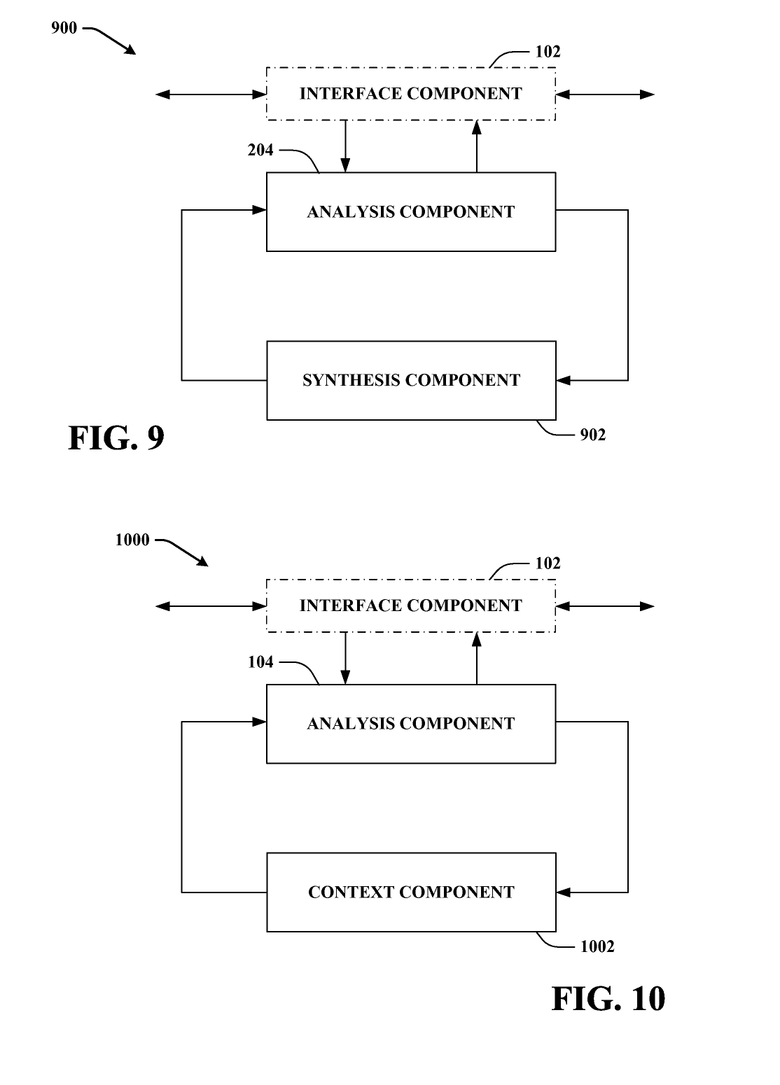

FIG. 9 provides a further depiction of a system 900 that effectuates and facilitates generation of alternative expressions or phrasings for proper nouns, short descriptions, or places in accordance with an aspect of the claimed subject matter. As illustrated analysis component 104 (or inquiry component 302) can, for example, employ synthesis component 902 to combine, or filter information received from a variety of inputs (e.g., text, speech, gaze, environment, audio, images, gestures, noise, temperature, touch, smell, handwriting, pen strokes, analog signals, digital signals, vibration, motion, altitude, location, GPS, wireless, etc.), in raw or parsed (e.g. processed) form. Synthesis component 902 through combining and filtering can provide a set of information that can be more informative, or accurate (e.g., with respect to an entity's communicative or informational goals) and information from just one or two modalities, for example. As discussed in connection with FIG. 8, the data fusion component 802 can be employed to learn correlations between different data types, and the synthesis component 902 can employ such correlations in connection with combining, or filtering the input data.

FIG. 10 provides a further illustration of a system 1000 that can effectuate and facilitate generation of alternative expressions or phrasings for proper nouns, short descriptions, or places in accordance with an aspect of the claimed subject matter. As illustrated analysis component 104 (or inquiry component 302) can, for example, employ context component 1002 to determine context associated with a particular action or set of input data. As can be appreciated, context can play an important role with respect understanding meaning associated with particular sets of input, or intent of an individual or entity. For example, many words or sets of words can have double meanings (e.g., double entendre), and without proper context of use or intent of the words the corresponding meaning can be unclear thus leading to increased probability of error in connection with interpretation or translation thereof. The context component 1002 can provide current or historical data in connection with inputs to increase proper interpretation of inputs. For example, time of day may be helpful to understanding an input—in the morning, the word “drink” would likely have a high a probability of being associated with coffee, tea, or juice as compared to be associated with a soft drink or alcoholic beverage during late hours. Context can also assist in interpreting uttered words that sound the same (e.g., steak and, and stake). Knowledge that it is near dinnertime of the user as compared to the user campaign would greatly help in recognizing the following spoken words “I need a steak/stake”. Thus, if the context component 802 had knowledge that the user was not camping, and that it was near dinnertime, the utterance would be interpreted as “steak”. On the other hand, if the context component 1002 knew (e.g., via GPS system input) that the user recently arrived at a camping ground within a national park; it might more heavily weight the utterance as “stake”.

In view of the foregoing, it is readily apparent that utilization of the context component 1002 to consider and analyze extrinsic information can substantially facilitate determining meaning of sets of inputs.

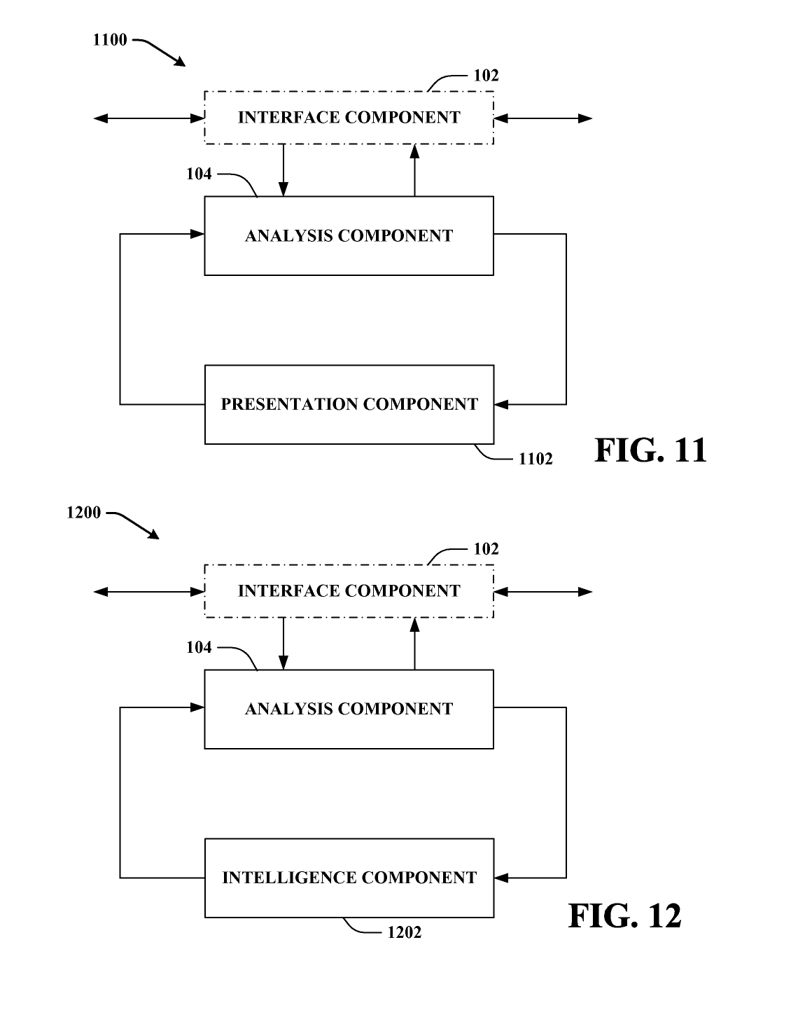

FIG. 11 a further illustration of a system 1100 that effectuates and facilitates generation of alternative expressions or phrasings for short descriptions, proper nouns or places in accordance with an aspect of the claimed subject matter. As illustrated, system 1100 can include presentation component 1102 that can provide various types of user interface to facilitate interaction between a user and any component coupled to analysis component 104 (or inquiry component 302). As illustrated, presentation component 1102 is a separate entity that can be utilized with analysis component 104 (or inquiry component 302). However, it is to be appreciated that presentation component 1102 and/or other similar view components can be incorporated into analysis component 104 (or inquiry component 302) and/or a standalone unit. Presentation component 1102 can provide one or more graphical user interface, command line interface, and the like. For example, the graphical user interface can be rendered that provides the user with a region or means to load, import, read, etc., data, and can include a region to present the results of such. These regions can comprise known text and/or graphic regions comprising dialog boxes, static controls, drop-down menus, list boxes, pop-up menus, edit controls, combo boxes, radio buttons, check boxes, push buttons, and graphic boxes. In addition, utilities to facilitate the presentation such as vertical and/or horizontal scrollbars for navigation and toolbar buttons to determine whether a region will be viewable can be employed. For example, the user can interact with one or more of the components coupled and/or incorporated into analysis component 104 (or inquiry component 302)

Users can also interact with regions to select and provide information via various devices such as a mouse, roller ball, keypad, keyboard, and/or voice activation, for example. Typically, the mechanism such as a push button or the enter key on the keyboard can be employed subsequent to entering the information in order to initiate, for example, a query. However, it is to be appreciated that the claimed subject matter is not so limited. For example, nearly highlighting a checkbox can initiate information conveyance. In another example, a command line interface can be employed. For example, the command line interface can prompt (e.g., via text message on a display and an audio tone) the user for information via a text message. The user can then provide suitable information, such as alphanumeric input corresponding to an option provided in the interface prompt or an answer to a question posed in the prompt. It is to be appreciated that the command line interface can be employed in connection with a graphical user interface and/or application programming interface (API). In addition, the command line interface can be employed in connection with hardware (e.g., video cards) and/or displays (e.g., black-and-white, and EGA) with limited graphic support, and/or low bandwidth communication channels.

FIG. 12 depicts a system 1200 that employs artificial intelligence to effectuate and facilitate generation of alternative expressions or phrasings for proper nouns, short descriptions, or places in accordance with an aspect of the subject matter as claimed. Accordingly, as illustrated, system 1200 can include an intelligence component 1202 that can employ a probabilistic based or statistical based approach, for example, in connection with making determinations or inferences. Inferences can be based in part upon explicit training of classifiers (not shown) before employing system 100 (or system 300), or implicit training based at least in part upon system feedback and/or users previous actions, commands, instructions, and the like during use of the system. Intelligence component 1202 can employ any suitable scheme (e.g., neural networks, expert systems, Bayesian belief networks, support vector machines (SVMs), Hidden Markov Models (HMMs), fuzzy logic, data fusion, etc.) in accordance with implementing various automated aspects described herein. Intelligence component 1202 can factor historical data, extrinsic data, context, data content, state of the user, and can compute cost of making an incorrect determination or inference versus benefit of making a correct determination or inference. Accordingly, a utility-based analysis can be employed with providing such information to other components or taking automated action. Ranking and confidence measures can also be calculated and employed in connection with such analysis.

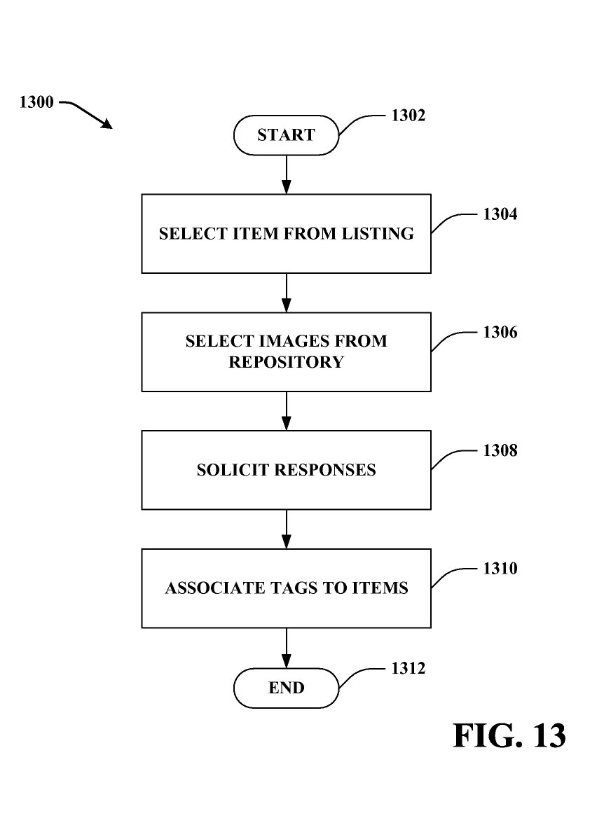

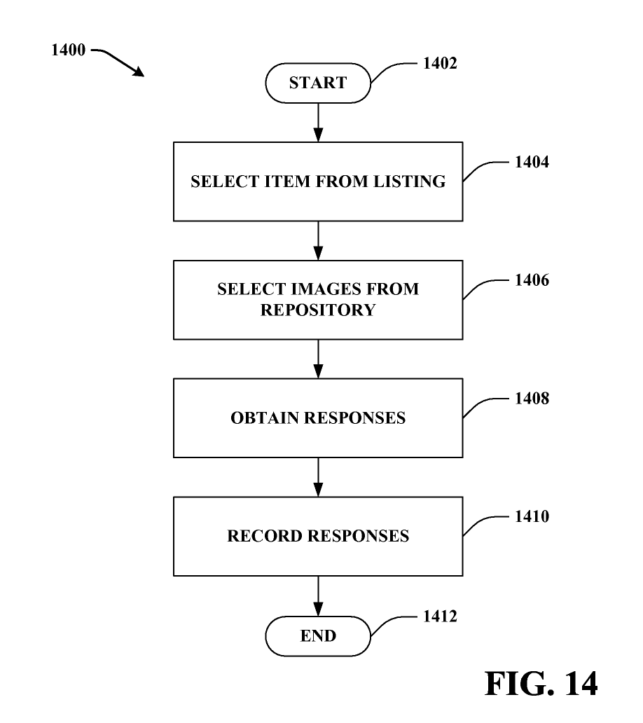

In view of the exemplary systems shown and described supra, methodologies that may be implemented in accordance with the disclosed subject matter will be better appreciated with reference to the flow charts of FIGS. 13-14. While for purposes of simplicity of explanation, the methodologies are shown and described as a series of blocks, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methodologies described hereinafter. Additionally, it should be further appreciated that the methodologies disclosed hereinafter and throughout this specification are capable of being stored on an article of manufacture to facilitate transporting and transferring such methodologies to computers.

The claimed subject matter can be described in the general context of computer-executable instructions, such as program modules, executed by one or more components. Generally, program modules can include routines, programs, objects, data structures, etc. that perform particular tasks or implement particular abstract data types. Typically the functionality of the program modules may be combined and/or distributed as desired in various aspects.

FIG. 13 provides a machine implemented methodology 1300 that effectuates and facilitates generation of alternative expressions or phrasings for short descriptions, proper nouns or places in accordance with an aspect of the claimed subject matter. At 1302 where various initialization tasks and background activities can be undertaken after which method 1300 can proceed to 1302. At 1304 items (e.g., names of businesses) from a supplied listing can be selected. At 1306 images can be selected from repositories or data storage devices. At 1308 the items selected from supplied listings and images obtained from repositories can be utilized to frame a query with which to entice a human intermediary or test subject to elicit a relevant and appropriate response. At 1310 the elicited responses can be utilized as tags that can be clustered with the business that elicited the response.

FIG. 14 provides a machine implemented methodology 1400 that effectuates and facilitates generation of alternative expressions or phrasings for short descriptions, proper nouns or places in accordance with a further aspect of the claimed subject matter. Methodology 1400 can commence at 1402 where initialization and background tasks can be accomplished. At 1404 items from a supplied listing can be selected. Typically, listings can be supplied from local and remote storage facilities, the Internet, databases, data warehouses, and the like. At 1406 prompts and/or mnemonic images can be identified and selected from data repositories. At 1408 items selected from the supplied listings at 1404 and prompts and/or mnemonic image selected at 1406 can be paired and employed to compose a query directed to elicit an appropriate response from human intermediaries. At 1410 the elicited responses (e.g., vocalizations) can be associated with the corresponding items that evoked the responses and persisted in one or more compressed or uncompressed audio formats.

The claimed subject matter can be implemented via object oriented programming techniques. For example, each component of the system can be an object in a software routine or a component within an object. Object oriented programming shifts the emphasis of software development away from function decomposition and towards the recognition of units of software called “objects” which encapsulate both data and functions. Object Oriented Programming (OOP) objects are software entities comprising data structures and operations on data. Together, these elements enable objects to model virtually any real-world entity in terms of its characteristics, represented by its data elements, and its behavior represented by its data manipulation functions. In this way, objects can model concrete things like people and computers, and they can model abstract concepts like numbers or geometrical concepts.

As used in this application, the terms “component” and “system” are intended to refer to a computer-related entity, either hardware, a combination of hardware and software, or software in execution. For example, a component can be, but is not limited to being, a process running on a processor, a processor, a hard disk drive, multiple storage drives (of optical and/or magnetic storage medium), an object, an executable, a thread of execution, a program, and/or a computer. By way of illustration, both an application running on a server and the server can be a component. One or more components can reside within a process and/or thread of execution, and a component can be localized on one computer and/or distributed between two or more computers.

Artificial intelligence based systems (e.g., explicitly and/or implicitly trained classifiers) can be employed in connection with performing inference and/or probabilistic determinations and/or statistical-based determinations as in accordance with one or more aspects of the claimed subject matter as described hereinafter. As used herein, the term “inference,” “infer” or variations in form thereof refers generally to the process of reasoning about or inferring states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources. Various classification schemes and/or systems (e.g., support vector machines, neural networks, expert systems, Bayesian belief networks, fuzzy logic, data fusion engines . . . ) can be employed in connection with performing automatic and/or inferred action in connection with the claimed subject matter.

Furthermore, all or portions of the claimed subject matter may be implemented as a system, method, apparatus, or article of manufacture using standard programming and/or engineering techniques to produce software, firmware, hardware or any combination thereof to control a computer to implement the disclosed subject matter. The term “article of manufacture” as used herein is intended to encompass a computer program accessible from any computer-readable device or media. For example, computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick, key drive . . . ). Additionally it should be appreciated that a carrier wave can be employed to carry computer-readable electronic data such as those used in transmitting and receiving electronic mail or in accessing a network such as the Internet or a local area network (LAN). Of course, those skilled in the art will recognize many modifications may be made to this configuration without departing from the scope or spirit of the claimed subject matter.

Some portions of the detailed description have been presented in terms of algorithms and/or symbolic representations of operations on data bits within a computer memory. These algorithmic descriptions and/or representations are the means employed by those cognizant in the art to most effectively convey the substance of their work to others equally skilled. An algorithm is here, generally, conceived to be a self-consistent sequence of acts leading to a desired result. The acts are those requiring physical manipulations of physical quantities. Typically, though not necessarily, these quantities take the form of electrical and/or magnetic signals capable of being stored, transferred, combined, compared, and/or otherwise manipulated.

It has proven convenient at times, principally for reasons of common usage, to refer to these signals as bits, values, elements, symbols, characters, terms, numbers, or the like. It should be borne in mind, however, that all of these and similar terms are to be associated with the appropriate physical quantities and are merely convenient labels applied to these quantities. Unless specifically stated otherwise as apparent from the foregoing discussion, it is appreciated that throughout the disclosed subject matter, discussions utilizing terms such as processing, computing, calculating, determining, and/or displaying, and the like, refer to the action and processes of computer systems, and/or similar consumer and/or industrial electronic devices and/or machines, that manipulate and/or transform data represented as physical (electrical and/or electronic) quantities within the computer's and/or machine's registers and memories into other data similarly represented as physical quantities within the machine and/or computer system memories or registers or other such information storage, transmission and/or display devices.

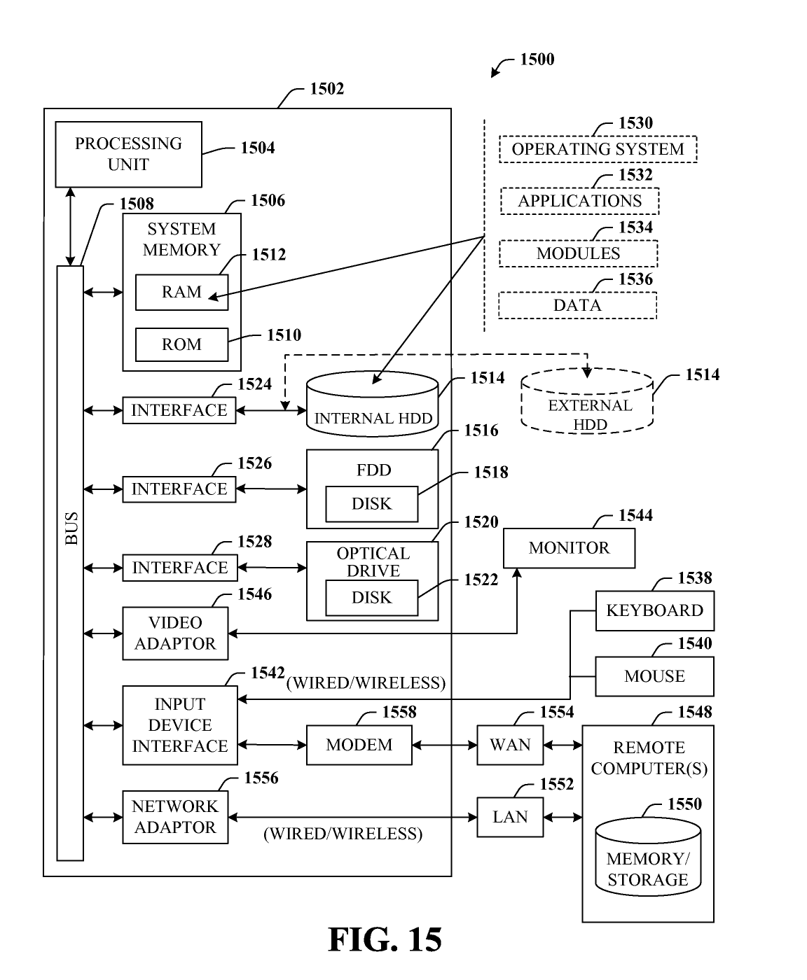

Referring now to FIG. 15, there is illustrated a block diagram of a computer operable to execute the disclosed system. In order to provide additional context for various aspects thereof, FIG. 15 and the following discussion are intended to provide a brief, general description of a suitable computing environment 1500 in which the various aspects of the claimed subject matter can be implemented. While the description above is in the general context of computer-executable instructions that may run on one or more computers, those skilled in the art will recognize that the subject matter as claimed also can be implemented in combination with other program modules and/or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multiprocessor computer systems, minicomputers, mainframe computers, as well as personal computers, hand-held computing devices, microprocessor-based or programmable consumer electronics, and the like, each of which can be operatively coupled to one or more associated devices.

The illustrated aspects of the claimed subject matter may also be practiced in distributed computing environments where certain tasks are performed by remote processing devices that are linked through a communications network. In a distributed computing environment, program modules can be located in both local and remote memory storage devices.

A computer typically includes a variety of computer-readable media. Computer-readable media can be any available media that can be accessed by the computer and includes both volatile and non-volatile media, removable and non-removable media. By way of example, and not limitation, computer-readable media can comprise computer storage media and communication media. Computer storage media includes both volatile and non-volatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital video disk (DVD) or other optical disk storage, magnetic cassettes, magnetic tape, magnetic disk storage or other magnetic storage devices, or any other medium which can be used to store the desired information and which can be accessed by the computer.

With reference again to FIG. 15, the exemplary environment 1500 for implementing various aspects includes a computer 1502, the computer 1502 including a processing unit 1504, a system memory 1506 and a system bus 1508. The system bus 1508 couples system components including, but not limited to, the system memory 1506 to the processing unit 1504. The processing unit 1504 can be any of various commercially available processors. Dual microprocessors and other multi-processor architectures may also be employed as the processing unit 1504.

The system bus 1508 can be any of several types of bus structure that may further interconnect to a memory bus (with or without a memory controller), a peripheral bus, and a local bus using any of a variety of commercially available bus architectures. The system memory 1506 includes read-only memory (ROM) 1510 and random access memory (RAM) 1512. A basic input/output system (BIOS) is stored in a non-volatile memory 1510 such as ROM, EPROM, EEPROM, which BIOS contains the basic routines that help to transfer information between elements within the computer 1502, such as during start-up. The RAM 1512 can also include a high-speed RAM such as static RAM for caching data.

The computer 1502 further includes an internal hard disk drive (HDD) 1514 (e.g., EIDE, SATA), which internal hard disk drive 1514 may also be configured for external use in a suitable chassis (not shown), a magnetic floppy disk drive (FDD) 1516, (e.g., to read from or write to a removable diskette 1518) and an optical disk drive 1520, (e.g., reading a CD-ROM disk 1522 or, to read from or write to other high capacity optical media such as the DVD). The hard disk drive 1514, magnetic disk drive 1516 and optical disk drive 1520 can be connected to the system bus 1508 by a hard disk drive interface 1524, a magnetic disk drive interface 1526 and an optical drive interface 1528, respectively. The interface 1524 for external drive implementations includes at least one or both of Universal Serial Bus (USB) and IEEE 1494 interface technologies. Other external drive connection technologies are within contemplation of the claimed subject matter.

The drives and their associated computer-readable media provide nonvolatile storage of data, data structures, computer-executable instructions, and so forth. For the computer 1502, the drives and media accommodate the storage of any data in a suitable digital format. Although the description of computer-readable media above refers to a HDD, a removable magnetic diskette, and a removable optical media such as a CD or DVD, it should be appreciated by those skilled in the art that other types of media which are readable by a computer, such as zip drives, magnetic cassettes, flash memory cards, cartridges, and the like, may also be used in the exemplary operating environment, and further, that any such media may contain computer-executable instructions for performing the methods of the disclosed and claimed subject matter.

A number of program modules can be stored in the drives and RAM 1512, including an operating system 1530, one or more application programs 1532, other program modules 1534 and program data 1536. All or portions of the operating system, applications, modules, and/or data can also be cached in the RAM 1512. It is to be appreciated that the claimed subject matter can be implemented with various commercially available operating systems or combinations of operating systems.

A user can enter commands and information into the computer 1502 through one or more wired/wireless input devices, e.g., a keyboard 1538 and a pointing device, such as a mouse 1540. Other input devices (not shown) may include a microphone, an IR remote control, a joystick, a game pad, a stylus pen, touch screen, or the like. These and other input devices are often connected to the processing unit 1504 through an input device interface 1542 that is coupled to the system bus 1508, but can be connected by other interfaces, such as a parallel port, an IEEE 1494 serial port, a game port, a USB port, an IR interface, etc.

A monitor 1544 or other type of display device is also connected to the system bus 1508 via an interface, such as a video adapter 1546. In addition to the monitor 1544, a computer typically includes other peripheral output devices (not shown), such as speakers, printers, etc.

The computer 1502 may operate in a networked environment using logical connections via wired and/or wireless communications to one or more remote computers, such as a remote computer(s) 1548. The remote computer(s) 1548 can be a workstation, a server computer, a router, a personal computer, portable computer, microprocessor-based entertainment appliance, a peer device or other common network node, and typically includes many or all of the elements described relative to the computer 1502, although, for purposes of brevity, only a memory/storage device 1550 is illustrated. The logical connections depicted include wired/wireless connectivity to a local area network (LAN) 1552 and/or larger networks, e.g., a wide area network (WAN) 1554. Such LAN and WAN networking environments are commonplace in offices and companies, and facilitate enterprise-wide computer networks, such as intranets, all of which may connect to a global communications network, e.g., the Internet.

When used in a LAN networking environment, the computer 1502 is connected to the local network 1552 through a wired and/or wireless communication network interface or adapter 1556. The adaptor 1556 may facilitate wired or wireless communication to the LAN 1552, which may also include a wireless access point disposed thereon for communicating with the wireless adaptor 1556.

When used in a WAN networking environment, the computer 1502 can include a modem 1558, or is connected to a communications server on the WAN 1554, or has other means for establishing communications over the WAN 1554, such as by way of the Internet. The modem 1558, which can be internal or external and a wired or wireless device, is connected to the system bus 1508 via the serial port interface 1542. In a networked environment, program modules depicted relative to the computer 1502, or portions thereof, can be stored in the remote memory/storage device 1550. It will be appreciated that the network connections shown are exemplary and other means of establishing a communications link between the computers can be used.

The computer 1502 is operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This includes at least Wi-Fi and Bluetooth™ wireless technologies. Thus, the communication can be a predefined structure as with a conventional network or simply an ad hoc communication between at least two devices.

Wi-Fi, or Wireless Fidelity, allows connection to the Internet from a couch at home, a bed in a hotel room, or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11x (a, b, g, etc.) to provide secure, reliable, fast wireless connectivity. A Wi-Fi network can be used to connect computers to each other, to the Internet, and to wired networks (which use IEEE 802.3 or Ethernet).

Wi-Fi networks can operate in the unlicensed 2.4 and 5 GHz radio bands. IEEE 802.11 applies to generally to wireless LANs and provides 1 or 2 Mbps transmission in the 2.4 GHz band using either frequency hopping spread spectrum (FHSS) or direct sequence spread spectrum (DSSS). IEEE 802.11a is an extension to IEEE 802.11 that applies to wireless LANs and provides up to 54 Mbps in the 5 GHz band. IEEE 802.11a uses an orthogonal frequency division multiplexing (OFDM) encoding scheme rather than FHSS or DSSS. IEEE 802.11b (also referred to as 802.11 High Rate DSSS or Wi-Fi) is an extension to 802.11 that applies to wireless LANs and provides 11 Mbps transmission (with a fallback to 5.5, 2 and 1 Mbps) in the 2.4 GHz band. IEEE 802.11 g applies to wireless LANs and provides 20+Mbps in the 2.4 GHz band. Products can contain more than one band (e.g., dual band), so the networks can provide real-world performance similar to the basic 10BaseT wired Ethernet networks used in many offices.

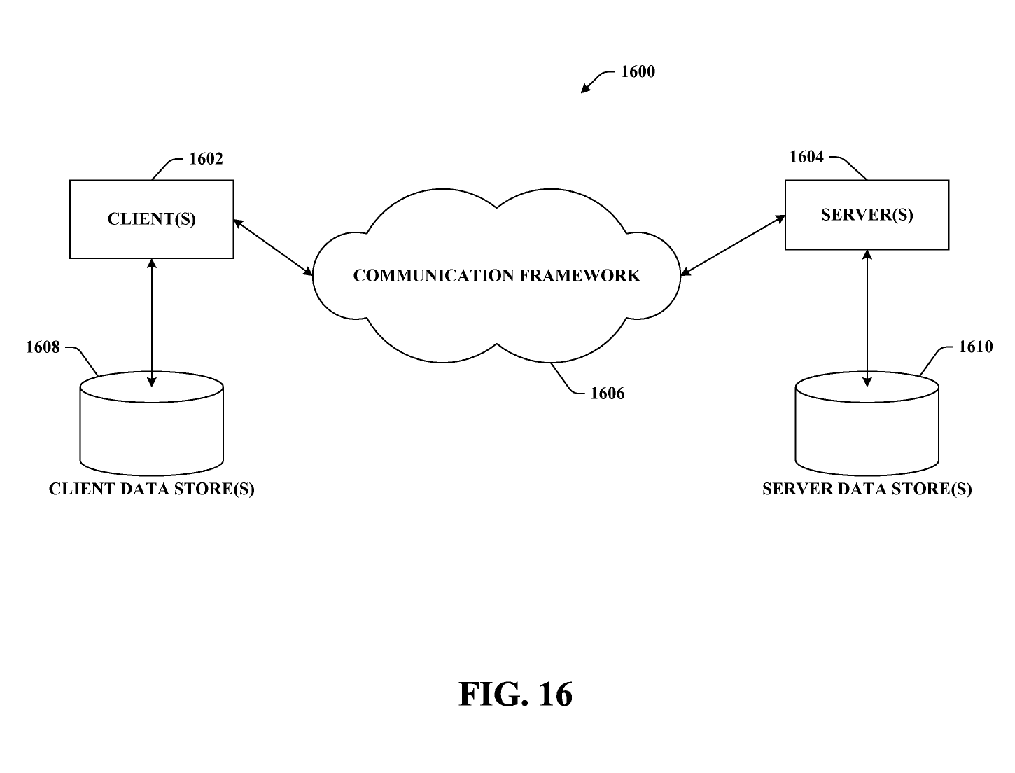

Referring now to FIG. 16, there is illustrated a schematic block diagram of an exemplary computing environment 1600 for processing the disclosed architecture in accordance with another aspect. The system 1600 includes one or more client(s) 1602. The client(s) 1602 can be hardware and/or software (e.g., threads, processes, computing devices). The client(s) 1602 can house cookie(s) and/or associated contextual information by employing the claimed subject matter, for example.

The system 1600 also includes one or more server(s) 1604. The server(s) 1604 can also be hardware and/or software (e.g., threads, processes, computing devices). The servers 1604 can house threads to perform transformations by employing the claimed subject matter, for example. One possible communication between a client 1602 and a server 1604 can be in the form of a data packet adapted to be transmitted between two or more computer processes. The data packet may include a cookie and/or associated contextual information, for example. The system 1600 includes a communication framework 1606 (e.g., a global communication network such as the Internet) that can be employed to facilitate communications between the client(s) 1602 and the server(s) 1604.

Communications can be facilitated via a wired (including optical fiber) and/or wireless technology. The client(s) 1602 are operatively connected to one or more client data store(s) 1608 that can be employed to store information local to the client(s) 1602 (e.g., cookie(s) and/or associated contextual information). Similarly, the server(s) 1604 are operatively connected to one or more server data store(s) 1610 that can be employed to store information local to the servers 1604.

What has been described above includes examples of the disclosed and claimed subject matter. It is, of course, not possible to describe every conceivable combination of components and/or methodologies, but one of ordinary skill in the art may recognize that many further combinations and permutations are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A system implemented on a machine that effectuates and facilitates generation of alternative expressions or phrasings for short descriptions, proper nouns or places, comprising:
a component that receives from an interface at least one of listings or input from human intermediaries, the component utilizes the listings to select and associate an item from the listings with a prompt stored in a database, the component displays the item from the listings initially and further displays the prompt subsequently, the prompt obscures the item, based at least in part on the item and the prompt utilized the component constructs a motivational statement employed to elicit a response from the human intermediaries, the response persisted by the component to a storage component.

2. The system of claim 1, the listings include at least one of a catalogue of items or search terms, information retrieved based at least in part on the search terms, each item from the catalogue of items includes a title.

3. The system of claim 2, the title includes at least one of business names, song titles, company directory names, short descriptions, or short phrases.

4. The system of claim 1, the storage component includes a transcription file formatted in at least one of a text format or an audio format, the transcription file includes the response elicited from the human intermediaries.

5. The system of claim 1, the prompt includes at least one of images, music jingles, advertising media, viral videos, or corporate logos.

6. The claim of claim 1, the component utilizes the response from the human intermediaries to assign points to the human intermediaries that have a corresponding response.

7. The claim of claim 1, the component utilizes at least one attribute associated with the prompt to associate the item with the prompt.

8. The system of claim 1, the component employs at least one of artificial intelligence modalities or machine learning techniques to generate the motivational statement.

9. A machine implemented method that facilitates and effectuates generation of alternative expressions or phrasings for proper nouns, short descriptions, or places, comprising:
employing a listing to select an item from the listing;
associating the item with a prompt stored in a database;
displaying the item;
obscuring the item with the prompt;
constructing a motivational statement based on the item and the prompt;
eliciting a response from human intermediaries based on the motivational statement; and
storing the response to a persistence device.

10. The method of claim 9, further comprises assigning points to the human intermediaries based on a correspondence of the response supplied by the human intermediaries.

11. The method of claim 9, the human intermediaries includes a live intermediary emulator that utilizes previously elicited alternative phrasings as the response.

12. The method of claim 9, the constructing further comprising employing at least one of artificial intelligence or machine learning.

13. The method of claim 9, further comprising associating the response from the human intermediaries with the item.

14. The method of claim 9, the listing includes one of labels or search terms.

15. The method of claim 9, the storing further comprising generating a file formatted in at least one of a text format or an audiovisual format.

16. The method of claim 9, the response includes one or more alternative phrasings for the item.

17. A system that effectuates and facilitates generation of alternative expressions or phrasings for at least one of proper nouns, short descriptions, or places, comprising:
means for selecting items from a listing of business names;
means for selectively retrieving images from repositories;
means for eliciting responses from a user; and
means for associating tags to items based at least in part on the responses from the user.

18. The system of claim 17, the means for selecting utilizes at least one of a predetermined ordering or a dynamically determined ordering to identify items from the listing.

19. The system of claim 17, the means for selectively retrieving employs the items from the listing of business names to retrieve the images from the repositories

20. The system of claim 17, the means for eliciting responses generates a motivational statement to which the user responds.
